(19) United States
(12) Patent Application Publication
(10) Pub. No.: US 2023/0172327 A1
(43) Pub. Date: Jun. 8, 2023

(54) Easy Open Solar Patio Umbrella Device

(71) Applicant: Peter Wood, Belfast, ME (US)

(72) Inventor: Peter Wood, Belfast, ME (US)

(21) Appl. No.: 17/723,978

(22) Filed: Apr. 19, 2022

Related U.S. Application Data
(60) Provisional application No. 63/287,238, filed on Dec. 8, 2021.

(51) Int. Cl. A45B 25/14; H02S 20/32

(52) U.S. Cl. CPC A45B 25/143; H02S 20/32; A45B 2200/1027; A45B 2200/1063

(57) ABSTRACT

The present invention relates to a novel solar powered patio umbrella device which provides users with an improved patio umbrella capable of automatically expanding and retracting when exposed to sunlight. The device comprises at least one rotating solar panel that powers an automated opening and closing system; and at least one battery that receives power from the at least one rotating solar panel. Thus, the umbrella opens when the battery is at full charge and lowers when the battery is at a lower percentage. In this manner, the device simplifies use of the umbrella and eliminates the need to manually crank the umbrella open to use it.

### CROSS-REFERENCE TO RELATED APPLICATION

The present application claims priority to, and the benefit of, U.S. Provisional Application No. 63/287,238, which was filed on Dec. 8, 2021 and is incorporated herein by reference in its entirety.

### FIELD OF THE INVENTION

The present invention relates generally to the field of patio umbrellas. More specifically, the present invention relates to an improved solar powered patio umbrella device that provides users with an umbrella capable of automatically expanding and retracting when exposed to sunlight. Specifically, the device comprises a rotating solar panel that powers an automated opening and closing system. The system is powered by a battery that receives power from the solar panel. Accordingly, the present disclosure makes specific reference thereto. Nonetheless, it is to be appreciated that aspects of the present invention are also equally applicable to other like applications, devices and methods of manufacture.

### BACKGROUND

By way of background, beach, patio and table umbrellas are used to provide protection from high temperatures and/or vigorous sunlight. Thus, these umbrellas are enjoyable for users to relax underneath, especially during sunny days. However, constantly adjusting the umbrella to block the sun can be annoying and frustrating. Further, manually cranking the umbrella to expand it or retract it can be time consuming and it may be difficult for those with limited physical strength and dexterity.

Additionally, besides having to adjust the umbrella to block the sun, users may have to adjust the umbrella base. However, patio umbrella bases are typically either too heavy to move, or to easily moved that it will blow over in the wind. Thus, users who buy these bases end up positioning themselves and their chairs in undesirable positions, just to be in the shaded area of the umbrella instead of undertaking the moving or rolling of the heavy umbrella and base.

Therefore, a novel solar powered patio umbrella device is needed that can automatically expand and/or retract when exposed to sunlight. The solar powered umbrella device may either fit on a patio table with a stand, dug into the sand at the beach, or placed outside any given area that requires its need. During dusk, nighttime hours or during periods where there is insufficient sunlight, the umbrella can still be powered up by means of rechargeable batteries powered from the solar panels. Further, a useful device is needed that reduces the amount of manual force needed to adjust the umbrella's position.

Therefore, there exists a long-felt need in the art for a solar powered patio umbrella device that provides users with a patio umbrella capable of automatically expanding and retracting when exposed to sunlight. There is also a long-felt need in the art for a solar powered patio umbrella device that eliminates the need to manually crank an umbrella open to use it. Further, there is a long-felt need in the art for a solar powered patio umbrella device that simplifies the means for adjusting an umbrella to block the sun. Moreover, there is a long-felt need in the art for a device that offers ease and convenience for all users enjoying time underneath a patio umbrella. Further, there is a long-felt need in the art for a solar powered patio umbrella device that is equipped with a rotating solar panel that powers an automated opening and closing system. Finally, there is a long-felt need in the art for a solar powered patio umbrella device that automatically raises or lowers based on exposure to sunlight or other ambient light.

The subject matter disclosed and claimed herein, in one embodiment thereof, comprises a solar powered patio umbrella device. The device is designed to offer ease and convenience for all users enjoying time underneath a patio umbrella. Specifically, the solar powered patio umbrella device provides users with an improved patio umbrella capable of automatically expanding and retracting when exposed to sunlight. The device comprises at least one rotating solar panel that powers an automated opening and closing system; and at least one battery that receives power from the at least one rotating solar panel. Thus, the umbrella opens when the battery is at full charge and lowers when the battery is at a lower percentage. Further, the umbrella may raise or lower based on a ambient light setting as well.

In this manner, the solar powered patio umbrella device of the present invention accomplishes all of the forgoing objectives and provides users with a device that offers ease and convenience for all users enjoying time underneath a patio umbrella. The device provides users with an improved patio umbrella capable of automatically expanding and retracting when exposed to sunlight. The device simplifies use of the umbrella and eliminates the need to manually crank the umbrella open to use it.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a solar powered patio umbrella device. The device provides users with an improved patio umbrella capable of automatically expanding and retracting when exposed to sunlight. Specifically, the solar powered patio umbrella device simplifies use of the umbrella and eliminates the need to manually crank the umbrella open to use it. The device comprises an umbrella; at least one rotating solar panel that powers an automated opening and closing system for the umbrella; and at least one battery that receives power from the at least one rotating solar panel. Thus, the umbrella opens when the battery is at full charge and lowers when the battery is at a lower percentage.

The umbrella may be applied to an outdoor table, can be stand alone, and/or used as a beach umbrella. The umbrella has a supporting member, shaft, or pole, a canopy supported by a plurality of ribs, and at least one rotating solar panel attached to the canopy. The rechargeable batteries serve as a method of powering the umbrella after being charged by the at least one rotating solar panel or after the sun has set. Typically, the rechargeable batteries can be a Lithium Ion rechargeable battery pack. The canopy may be made up of one, several or many different pieces of material, such as synthetic, cotton, vinyl or a blend of different materials, etc. If possible, the material may be water-resistant and/or fire retardant.

The plurality of ribs and the umbrella's supporting member, the shaft, or pole, may be made of, but not limited to, a metal alloy, or a metal such as aluminum or stainless steel, fiberglass, carbon fiber or plastic, etc. Further, the base of the umbrella may be built of a material of satisfactory weight, or built to be filled with a material of sufficient weight, for example, water or stones. The size and shape of the canopy is not predominantly restricted and depends partly on the particular application preferred. The supporting member, the shaft, or pole is sized suitably so that the canopy, in its opened form, is of the preferred height. Further, the canopy is opened via typical opening means, such as, but not limited to, a “slot and key” arrangement, a roll up, or a push up design, which may be applied in the supporting member to open and close the canopy.

The present invention comprises at least one rotating solar panel attached to the canopy of the umbrella which is capable of receiving energy from the sun. The solar panels are placed so that when the canopy is in an open position, the solar panel can rotate and tilt toward the sun. Hence, this facilitates the solar panel to encapsulate sufficient and, if possible, an optimal amount of solar energy for the umbrella. The solar panels should be kept free of any items that may reduce the available sunlight rays from reaching the solar panels.

In one embodiment, the solar powered patio umbrella device comprises a motor connected to the umbrella, and a controller connected to the motor for controlling the motor. A rechargeable battery is then connected to the controller, and a solar panel is connected to and provides a power source to the battery. The controller uses the sun's power produced during periods of daylight hours, collected from the solar panels, distributed to the rechargeable batteries to power the motor which controls the retraction and/or expansion of the umbrella. Typically, the umbrella has hollow ribs and/or a hollow supporting member that serve as a conduit for passing electrical wiring through when connecting the solar panels and batteries. Further, the one or more rechargeable batteries, the motor, and/or the controller are preferably mounted on or within the supporting member of the umbrella in order to reduce the invasiveness and obviousness of these devices.

In another embodiment, the automated umbrella device comprises a mobile application; an umbrella; a motor connected to the umbrella; a controller connected to the motor, wherein the controller is configured to wirelessly communicate with the mobile application; a rechargeable battery connected to the controller; and a solar panel connected to and providing a power source to the battery. For purposes of this document, a connection may be a direct connection or an indirect connection (i.e., via intervening elements). Two devices are “in communication” if they are directly or indirectly connected so that they can communicate electronic signals between them.

Specifically, positioned on the supporting member of the umbrella is a wireless control unit and rechargeable batteries to power the electronics and umbrella motor. The rechargeable batteries are connected to and charged via solar panels located on top of the umbrella. The wireless control unit is connected to and controls the umbrella motor to retract and expand the umbrella. The wireless control unit is also wirelessly connected to a smartphone application on a smartphone using Bluetooth.

In another embodiment, the umbrella device incorporates an LCD monitor typically positioned on the supporting member. The LCD monitor is in communication with the battery and controller and alerts a user as to the battery life of the batteries. The LCD monitor also comprises an override power switch, which allows a user to manually open or close the umbrella.

In another embodiment, the umbrella could also include a stand at the bottom of the supporting member, so as to maintain the umbrella in an erect position.

In another embodiment, the umbrella can be automatically raised or lowered based on a predetermined ambient light setting so that the umbrella is automatically opened or closes at dawn or dusk. The amount of ambient light can be detected, displayed, and set via a light sensor and the LCD monitor.

In yet another embodiment, a method of automatically expanding and retracting a patio umbrella when exposed to sunlight is described. The method includes the steps of providing a rotating solar panel that powers an automated opening and closing system. The method also comprises utilizing a battery which receives power from the solar panel to power the automated opening and closing system. Further, the method comprises raising the umbrella when the battery is at full charge and lowering the umbrella when the battery is at a lower percentage. Finally, the method may also comprise raising or lowering the umbrella based on a predetermined amount of ambient light.

In yet another embodiment of the present invention, a solar powered patio umbrella device is disclosed for automatically expanding and retracting an umbrella when exposed to sunlight. The device comprises a mobile application; an umbrella; a motor connected to the umbrella; a controller connected to the motor, the controller configured to wirelessly communicate with the mobile application; a rechargeable battery connected to the controller; and a solar panel connected to and providing a power source to the battery. Thus, users can sit underneath the expanded umbrella during the day without having to manually adjust the umbrella's position. Accordingly, the device offers ease and convenience for all users enjoying time underneath a patio umbrella.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the solar powered patio umbrella device of the present invention in use in accordance with the disclosed architecture;

FIG. 2A illustrates a perspective view of the solar panel of the solar powered patio umbrella device of the present invention in accordance with the disclosed architecture;

FIG. 2B illustrates a perspective view of the solar powered patio umbrella device of the present invention wherein the umbrella retracts without sunlight in accordance with the disclosed architecture;

FIG. 3 illustrates a perspective view of the LCD display showing the battery level and the current temperature outside in accordance with the disclosed architecture;

FIG. 4 illustrates a block diagram of the solar powered patio umbrella device in communication with a smart device via a wireless communication module in accordance with the disclosed architecture;

FIG. 5 illustrates a perspective view of the override switch which allows a user to open and close the umbrella manually in accordance with the disclosed architecture;

FIG. 6A illustrates a perspective view of the solar panel of the solar powered patio umbrella device rotating towards the direction of the sun in accordance with the disclosed architecture;

FIG. 6B illustrates a perspective view of the solar panel of the solar powered patio umbrella device rotating towards the direction of the sun in accordance with the disclosed architecture;

FIG. 6C illustrates a perspective view of the solar panel of the solar powered patio umbrella device rotating towards the direction of the sun in accordance with the disclosed architecture; and

FIG. 7 illustrates a flowchart showing the method of automatically expanding and retracting a patio umbrella when exposed to sunlight in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a solar powered patio umbrella device that provides users with a patio umbrella capable of automatically expanding and retracting when exposed to sunlight. There is also a long-felt need in the art for a solar powered patio umbrella device that eliminates the need to manually crank an umbrella open to use it. Further, there is a long-felt need in the art for a solar powered patio umbrella device that simplifies the means for adjusting an umbrella to block the sun. Moreover, there is a long-felt need in the art for a device that offers ease and convenience for all users enjoying time underneath a patio umbrella. Further, there is a long-felt need in the art for a solar powered patio umbrella device that is equipped with a rotating solar panel that powers an automated opening and closing system. Finally, there is a long-felt need in the art for a solar powered patio umbrella device that automatically raises or lowers based on exposure to sunlight.

The present invention, in one exemplary embodiment, is a novel solar powered patio umbrella device designed to offer ease and convenience for all users enjoying time underneath a patio umbrella. The device comprises at least one rotating solar panel that powers an automated opening and closing system; and at least one battery that receives power from the at least one rotating solar panel. Thus, the umbrella opens when the battery is at full charge and lowers when the battery is at a lower percentage. The present invention also includes a novel method of automatically expanding and retracting a patio umbrella when exposed to sunlight or other ambient light. The method includes the steps of providing a rotating solar panel that powers an automated opening and closing system. The method also comprises utilizing a battery which receives power from the solar panel. Further, the method comprises raising the umbrella when the battery is at full charge and lowering the umbrella when the battery is at a lower percentage. Finally, the method comprises raising or lowering the umbrella based on an ambient sunlight setting.

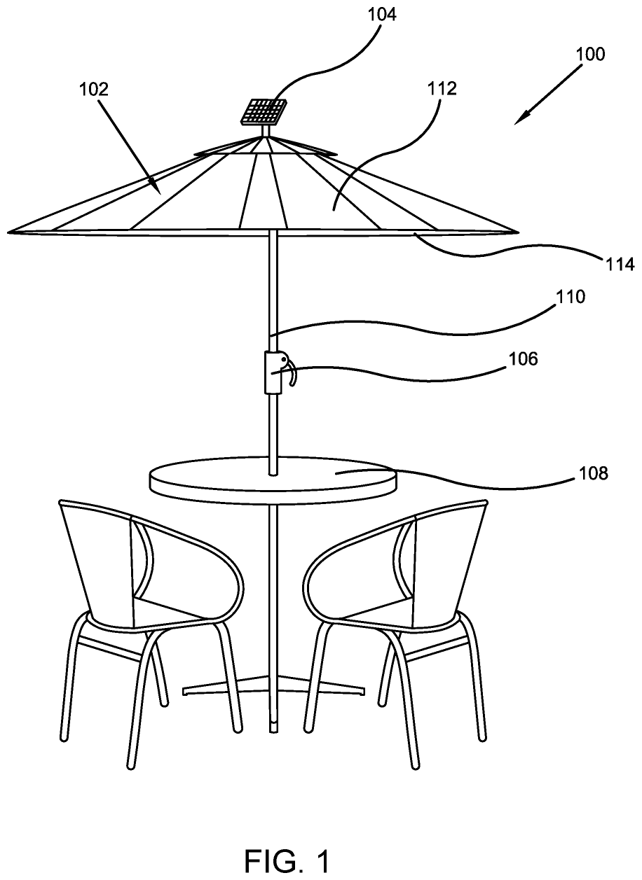

Referring initially to the drawings, FIG. 1 illustrates a perspective view of one embodiment of the solar powered patio umbrella device 100 of the present invention. In the present embodiment, the solar powered patio umbrella device 100 is an improved umbrella device that provides users with an umbrella capable of automatically expanding and retracting when exposed to sunlight. The device 100 is especially designed to allow any suitable user as is known in the art, to sit beneath an umbrella without having to manually adjust it. More specifically, the device 100 comprises an umbrella 102; at least one rotating solar panel 104 that powers an automated opening and closing system for the umbrella 102; and at least one battery 106 that receives power from the at least one rotating solar panel 104. Thus, the umbrella 102 opens when the battery 106 is at full charge and lowers when the battery 106 is at a lower percentage.

The umbrella 102 may be applied to an outdoor table 108, can be stand alone, and/or used as a beach umbrella. The umbrella 102 has a supporting member 110, shaft, or pole, a canopy 112 supported by a plurality of ribs 114, and at least one rotating solar panel 104 attached to the canopy 112. The rechargeable batteries 106 serve as a method of powering the umbrella 102 after being charged by the at least one rotating solar panel 104 or after the sun has set. Typically, the rechargeable batteries 106 can be a Lithium Ion rechargeable battery pack. The canopy 112 may be made up of one, several or many different pieces of material, such as synthetic, cotton, vinyl or a blend of different materials, etc., or any other suitable material as is known in the art. If possible, the material may be water-resistant and/or fire retardant.

The plurality of ribs 114 and the umbrella's supporting member 110, the shaft, or pole, may be made of, but not limited to, a metal alloy, or a metal, such as aluminum or stainless steel, fiberglass, carbon fiber or plastic, etc., or any other suitable material as is known in the art. Further, the base of the umbrella 102 may be built of a material of satisfactory weight, or built to be filled with a material of sufficient weight, for example, water or stones. The size and shape of the canopy 112 is not predominantly restricted and depends partly on the particular application preferred. The supporting member 110, the shaft, or pole is sized suitably so that the canopy 112, in its opened form, is of the preferred height. Further, the canopy 112 is opened via typical opening means, such as, but not limited to, a “slot and key” arrangement, a roll up, or a push up design, which may be applied in the supporting member 110 to open and close the canopy 112.

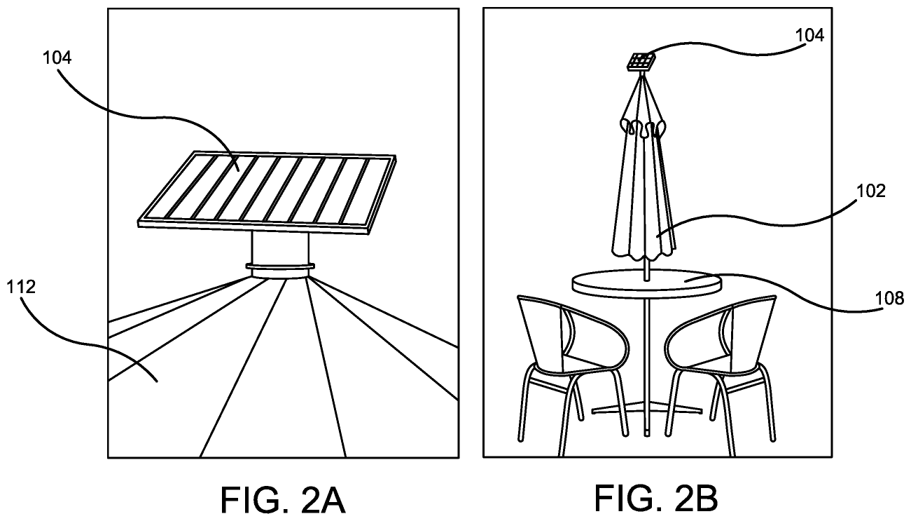

FIGS. 2A-B illustrate a perspective view of another embodiment of the solar powered patio umbrella device 100 of the present invention. The present invention comprises at least one rotating solar panel 104 attached to the canopy 112 of the umbrella 102 which is capable of receiving energy from the sun. The solar panels 104 are placed so that when the canopy 112 is in an open position, the solar panel 104 can rotate and tilt toward the sun (as shown in FIG. 2A). Hence, this facilitates the solar panel 104 to encapsulate sufficient and if possible, an optimal amount of solar energy for the umbrella 102. The solar panels 104 should be kept free of any items that may reduce the available sunlight rays from reaching the solar panels 104.

Further, in FIG. 2B, the solar powered patio umbrella device 100 is controlled via energy from the sun gathered via the solar panel 104, such that the umbrella 102 goes down when the sun goes down, and goes up when the sun has risen in the sky.

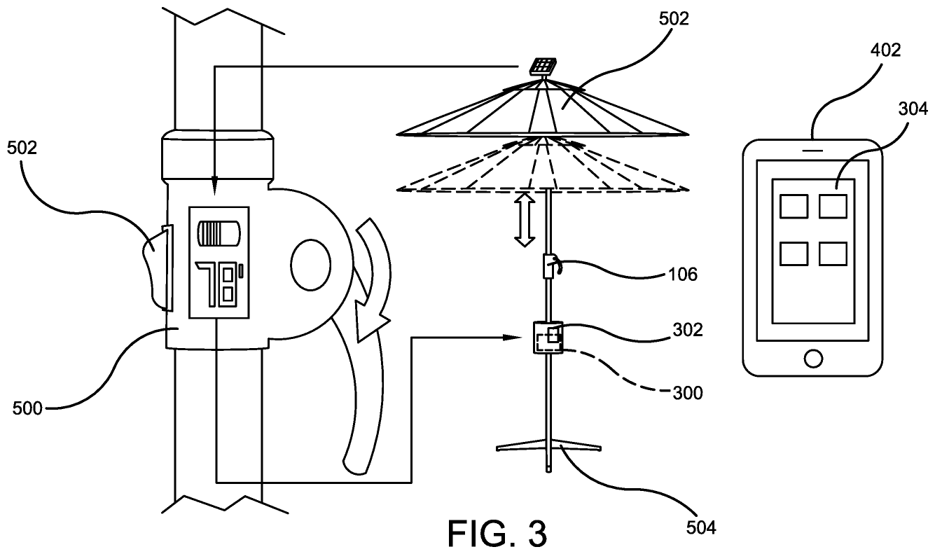

FIG. 3 illustrates a perspective view of another embodiment of the solar powered patio umbrella device 100 of the present invention. In this embodiment, the solar powered patio umbrella device 100 comprises a motor 300 connected to the umbrella 102, and a controller 302 connected to the motor 300 for controlling the motor 300. A rechargeable battery 106 is then connected to the controller 302, and a solar panel 104 is connected to and provides a power source to the battery 106. The controller 302 uses the sun's power produced during periods of daylight hours, collected from the solar panels 104, distributed to the rechargeable batteries 106 to power the motor 300 which controls the retraction and/or expansion of the umbrella 102. Typically, the umbrella 102 has hollow ribs 114 and/or a hollow supporting member 110 that serve as a conduit for passing electrical wiring through when connecting the solar panels 104 and batteries 106. Further, the one or more rechargeable batteries 106, the motor 300, and/or the controller 302 are preferably mounted on or within the supporting member 110 of the umbrella 102 in order to reduce the invasiveness and obviousness of these devices.

In another embodiment, the automated umbrella device 100 comprises a mobile application 304; an umbrella 102; a motor 300 connected to the umbrella 102; a controller 302 connected to the motor 300, wherein the controller 302 is configured to wirelessly communicate with the mobile application 304; a rechargeable battery 106 connected to the controller 302; and a solar panel 104 connected to and providing a power source to the battery 106. For purposes of this document, a connection may be a direct connection or an indirect connection (i.e., via intervening elements). Two devices are “in communication” if they are directly or indirectly connected so that they can communicate electronic signals between them.

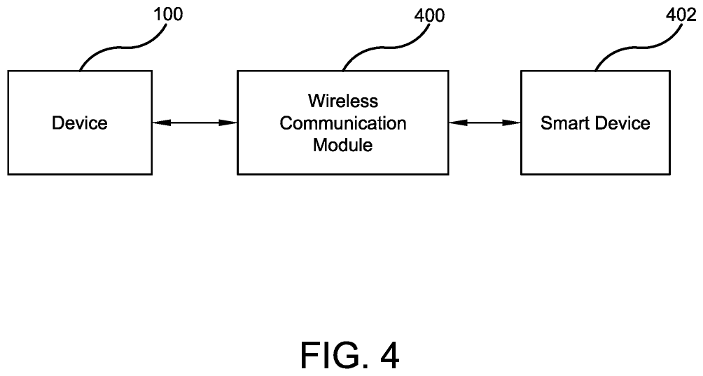

FIG. 4 illustrates the solar powered patio umbrella device 100 in communication with a wireless communication module 400. Specifically, positioned on the supporting member 110 of the umbrella 102 is a wireless control unit or module 400 and rechargeable batteries 106 to power the electronics and umbrella motor 300. The rechargeable batteries 106 are connected to and charged via solar panels 104 located on top of the umbrella 102. The wireless control unit or module 400 is connected to and controls the umbrella motor 300 to retract and expand the umbrella 102. The wireless control unit or module 400 is also wirelessly connected to a smartphone 402 and an application 304 on the smartphone 402 using Bluetooth.

For example, the proposed structure is a solar powered patio umbrella 100 that will allow the user to expand or retract the patio umbrella 102 to a desired location using their smartphone 402, and then automatically re-position the umbrella 102 as the sun moves. The umbrella 102 is powered by rechargeable batteries 106 powered by at least one solar panel 104. The umbrella 102 expands or contracts via at least one motor 300, positioned on the supporting member 110 or the canopy 112 or ribs 114.

The present disclosure connects to the user's smartphone 402 via BLE (Bluetooth low energy) and allows the user to control the umbrella 102 via their smartphone 402. When the mobile application 304 is launched on the smartphone 402, the user has to select the device 100 that they want to connect to (in case they have multiple umbrellas 102) and pair to it. After the phone 402 pairs, the user can control the umbrella 102 via buttons on the application 304. When one of the buttons is pressed in the application 304, a command is sent to the controller 302 which causes the drive motor 300 to activate.

The application 304 can also access databases via the Internet to determine the exact location of the sun at any given time to determine the position of the umbrella 102. The application 304 will request access for the user's location (determined by the smart phone 402 via GPS or other technology), and that information will allow the application 304 to calculate the exact direction of the sun to the user at any given time. Since the application 304 can know where the sun is, that allows the application 304 to drive the umbrella 102 without the user doing anything in order to keep the user in the shade at all times.

Thus, the application 304 uses location to determine the angle of the sun and positions the umbrella 102 between the sun and the smartphone 402 and therefore, the user. If the user repositions themself, they can again always use the manual controls to position the umbrella 102 to give them optimal shade, and then the umbrella 102 will continue in automatic mode to keep them in the shade afterwards.

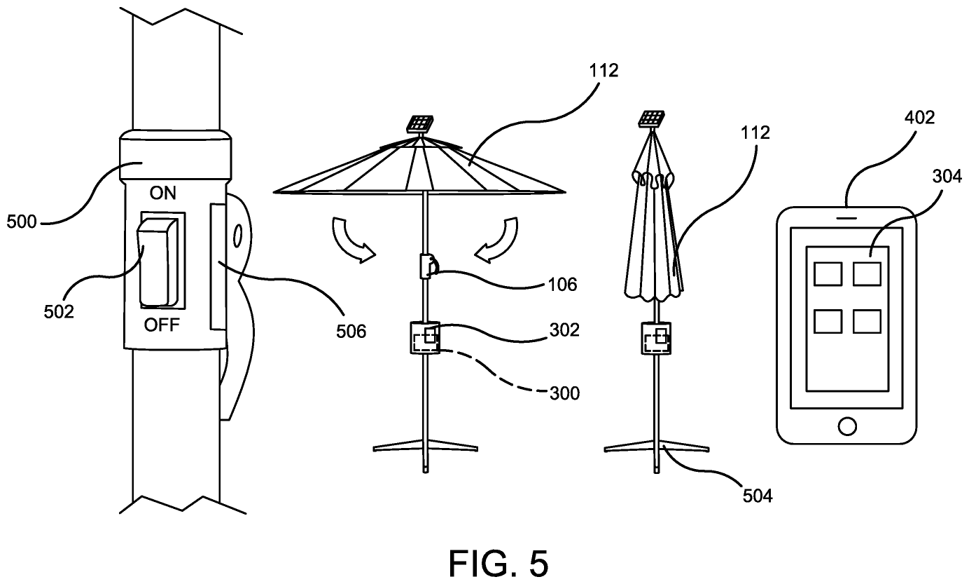

FIG. 5 illustrates a perspective view of another embodiment of the solar powered patio umbrella device 100 of the present invention. In this embodiment, the umbrella device 100 incorporates an LCD monitor 500 typically positioned on the supporting member 110, but could be positioned at any suitable location on the device 100. The LCD monitor 500 is in communication with the battery 106 and controller 302 and alerts a user as to the battery life of the batteries 106. The LCD monitor 500 may also comprise an override power switch 502, which allows a user to manually terminate power to the device in case of an impending storm or other inclement weather and to prevent the umbrella from being deployed. The override switch 502 could also be used to make the umbrella stay open if so desired (e.g., in the evening if the user still desires its use).

In another embodiment, the umbrella 102 could also include a stand 504 at the bottom of the supporting member 110, so as to maintain the umbrella 102 in an erect position.

In another embodiment, the umbrella 102 can be automatically raised or lowered based on the amount of ambient light present (e.g., to automatically close at night unless the override switch 502 is engaged). The amount of ambient light can be detected, displayed, and set via a light sensor 506 and the LCD monitor 500. Once set, the umbrella 102 would be automatically raised when a sufficient amount of ambient light is detected and lowered when the ambient light is no longer sufficient present.

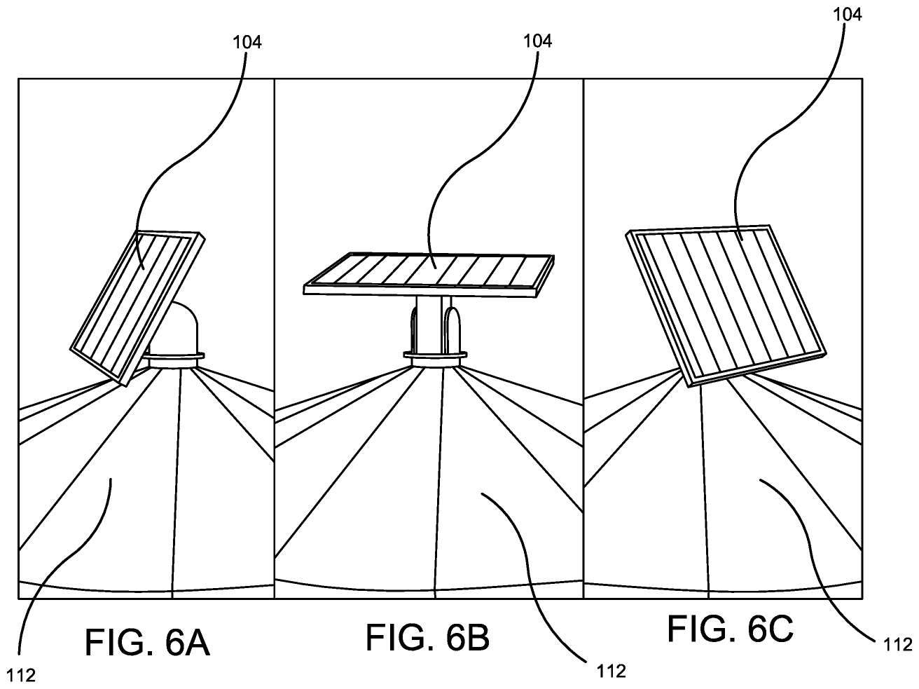

FIGS. 6A-C illustrates a perspective view of the solar panels 104 of the solar powered patio umbrella device 100 of the present invention disclosed for automatically expanding and retracting an umbrella 102 when exposed to sunlight. The device 100 comprises a rotating solar panel 104 connected to and providing a power source to the battery 106 for automatically raising and lowering the umbrella 102. The solar panels 104 are set to rotate towards the direction of the sun. Thus, users can sit underneath the expanded umbrella 102 during the day without having to manually adjust the umbrella's position. Accordingly, the device 100 offers ease and convenience for all users enjoying time underneath a patio umbrella 102.

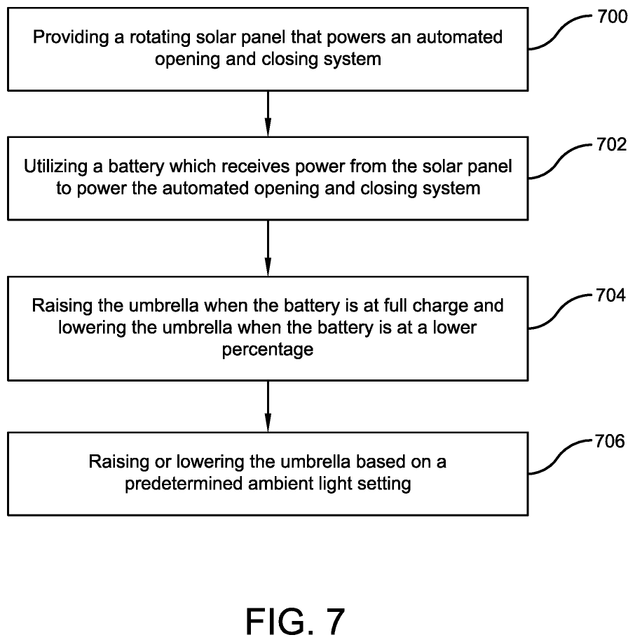

FIG. 7 illustrates a flowchart of the method of automatically expanding and retracting a patio umbrella when exposed to sunlight. The method includes the steps of at 700, providing a rotating solar panel that powers an automated opening and closing system. The method also comprises at 702, utilizing a battery which receives power from the solar panel to power the automated opening and closing system. Further, the method comprises at 704, raising the umbrella when the battery is at full charge and lowering the umbrella when the battery is at a lower percentage. Finally, the method comprises at 706, raising or lowering the umbrella based on a predetermined amount of ambient light present.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “solar powered patio umbrella device”, “automated umbrella device”, and “device” are interchangeable and refer to the solar powered patio umbrella device 100 of the present invention.

Notwithstanding the forgoing, the solar powered patio umbrella device 100 of the present invention can be of any suitable size and configuration as is known in the art without affecting the overall concept of the invention, provided that it accomplishes the above-stated objectives. One of ordinary skill in the art will appreciate that the solar powered patio umbrella device 100 as shown in FIGS. 1-7 is for illustrative purposes only, and that many other sizes and shapes of the solar powered patio umbrella device 100 are well within the scope of the present disclosure. Although the dimensions of the solar powered patio umbrella device 100 are important design parameters for user convenience, the solar powered patio umbrella device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A solar powered patio umbrella device for automatically expanding and retracting an umbrella when exposed to sunlight, the solar powered patio umbrella device comprising:
an umbrella;
at least one solar panel that provides power for the umbrella; and
at least one battery that receives power from the at least one solar panel, wherein the umbrella opens when the at least one battery is at full charge and lowers when the at least one battery is at a lower percentage of the full charge.

2. The solar powered patio umbrella device of claim 1, wherein the umbrella can be applied to an outdoor table or used as a stand-alone umbrella.

3. The solar powered patio umbrella device of claim 2, wherein the umbrella comprises a supporting member and a canopy supported by a plurality of ribs, and further wherein the at least one solar panel is attached to the canopy.

4. The solar powered patio umbrella device of claim 3, wherein the at least one solar panel rotates and tilts toward a direction of a sun to encapsulate sufficient solar energy to power the umbrella.

5. The solar powered patio umbrella device of claim 4, wherein the solar powered patio umbrella device is controlled via solar energy from the at least one solar panel, such that the umbrella goes down when the sun goes down and goes up when the sun has risen.

6. The solar powered patio umbrella device of claim 5 further comprising a motor connected to the umbrella, and a controller connected to the motor for controlling the motor.

7. The solar powered patio umbrella device of claim 6, wherein the at least one battery is in electrical communication with the controller, and the at least one solar panel is connected to and provides a power source to the at least one battery.

8. The solar powered patio umbrella device of claim 7, wherein the controller uses solar energy from the sun produced during daylight hours, collected from the at least one solar panel, distributed to the at least one battery to power the motor which controls retraction and expansion of the umbrella.

9. The solar powered patio umbrella device of claim 8 further comprising a mobile application, wherein the controller is configured to wirelessly communicate with the mobile application.

10. The solar powered patio umbrella device of claim 9, wherein the supporting member comprises a wireless communication module and the at least one battery to power the motor to retract and expand the umbrella.

11. The solar powered patio umbrella device of claim 10, wherein the wireless communication module is also wirelessly connected to a smartphone and an application on the smartphone using a Bluetooth connection.

12. The solar powered patio umbrella device of claim 11 further comprising an LCD monitor for displaying an amount of ambient light, a temperature, and a battery life, and also comprising an override power switch.

13. A solar powered patio umbrella device for automatically expanding and retracting an umbrella when exposed to the sunlight, the solar powered patio umbrella device comprising:
an umbrella comprising a supporting member and a canopy supported by a plurality of ribs;
at least one solar panel that provides a power for the umbrella and that is attached to the canopy, wherein the at least one solar panel rotates and tilts toward a direction of the sunlight to encapsulate sufficient solar energy for the umbrella;
at least one battery that receives the power from the at least one solar panel;
a motor connected to the umbrella; and
a controller connected to the motor for controlling the motor, wherein the at least one battery is connected to the controller, and the at least one solar panel is connected to and provides a power source to the at least one battery, and further wherein the controller uses sunlight produced during daylight hours, collected from the at least one solar panel, distributed to the at least one battery to power the motor which controls retraction and expansion of the umbrella.

14. The solar powered patio umbrella device of claim 13 further comprising a mobile application, wherein the controller is configured to wirelessly communicate with the mobile application.

15. The solar powered patio umbrella device of claim 14, wherein the supporting member comprises a wireless communication module and the at least one battery to power the motor to retract and expand the umbrella.

16. The solar powered patio umbrella device of claim 15, wherein the wireless communication module is wirelessly connected to a smartphone and an application on the smartphone using a Bluetooth connection.

17. The solar powered patio umbrella device of claim 13 further comprising an LCD monitor for displaying an amount of ambient light and a battery life, and also comprising an override power switch.

18. The solar powered patio umbrella device of claim 13, wherein the umbrella can also be automatically raised or lowered based on a predetermined ambient light.

19. A method of automatically expanding and retracting a patio umbrella when exposed to sunlight, the method comprising the steps of:
providing a rotating solar panel that powers an automated opening and closing system;
utilizing a battery which receives power from the solar panel to power the automated opening and closing system; and
raising the umbrella when the battery is at full charge and lowering the umbrella when the battery is at a percentage less than the full charge.

20. The method of claim 19 further comprising a step of raising or lowering the umbrella based on a predetermined ambient light setting being achieved.
